(19) United States
(12) Patent Application Publication
(10) Pub. No.: US 2014/0368899 A1
(43) Pub. Date: Dec. 18, 2014

(54) CONTROL SYSTEM TRUNK LINE ARCHITECTURE

(71) Applicant: SAGE Electrochromics, Inc., Faribault, MN (US)

(72) Inventor: Bryan D. Greer, Northfield, MN (US)

(21) Appl. No.: 13/920,651

(22) Filed: Jun. 18, 2013

(51) Int. Cl. G02F 1/163; H01R 43/26

(52) U.S. Cl. CPC G02F 1/163; H01R 43/26
USPC 359/275; 29/825

(57) ABSTRACT

The present disclosure relates generally to a wiring system for controlling one or more smart windows located within a building, and methods for installing such systems and/or replacing higher wattage systems with such systems.

### BACKGROUND OF THE INVENTION

The present invention relates to a control system wiring architecture for controlling smart windows, and methods and techniques for wiring such architectures.

As described in U.S. Pat. No. 7,710,671, the disclosure of which is hereby incorporated in its entirety herein, smart windows are glazing units that incorporate devices which have controllable optical and thermal transmission properties. The devices are generally in the form of layers either directly deposited on, or laminated to, the glass surface. Integration of the so-called smart windows into a building provides the opportunity to control internal light levels and temperature by adjusting the optical and thermal properties of the windows. Electrochromic devices, suspended particle devices (SPDs) polymer dispersed liquid crystal (PDLC), photovoltaic, and photochromic devices are all examples of devices that are incorporated in smart windows; light transmission in these particular devices is electrically controllable, and smart windows incorporating these devices are also known as electrically tintable windows.

Electrochromic devices are currently incorporated in a range of products, including smart windows, rear-view mirrors, and protective glass for museum display cases. Electrochromic devices are devices that change light (and heat) transmission properties in response to voltage applied across the device. Electrochromic devices can be fabricated which electrically switch between transparent and tinted states (where the transmitted light is colored and/or blocked). Furthermore, certain transition metal hydride electrochromic devices can be fabricated which switch between transparent and reflective states. A more detailed discussion of the functioning of electrochromic devices is found in Granqvist, C.-G., Nature Materials, v5, n2, February 2006, p 89-90. Electrochromic devices are currently the most promising electrically tintable devices for use in smart windows. Typical electrochromic devices (hereinafter “EC devices”) include a counter electrode layer, an electrochromic material layer which is deposited substantially parallel to the counter electrode layer, and an ionically conductive layer separating the counter electrode layer from the electrochromic layer respectively. In addition, two transparent conductive layers are substantially parallel to and in contact with the counter electrode layer and the electrochromic layer. Materials for making the counter electrode layer, the electrochromic material layer, the ionically conductive layer and the conductive layers are known and described, for example, in U.S. Pat. No. 8,228,587, the disclosure of which is hereby incorporated by reference in its entirety herein, and desirably are substantially transparent oxides or nitrides.

When an electrical potential is applied across the layered structure of the EC device, such as by connecting the respective conductive layers to a low voltage electrical source, ions, such as lithium (Li+) ions stored in the counter electrode layer, flow from the counter electrode layer, through the ion conductor layer and to the electrochromic layer. In addition, electrons flow from the counter electrode layer, around an external circuit including a low voltage electrical source, to the electrochromic layer so as to maintain charge neutrality in the counter electrode layer and the electrochromic layer. The transfer of ions and electrons to the electrochromic layer causes the optical characteristics of the electrochromic layer, and optionally the counter electrode layer in a complementary EC device, to change, thereby changing the coloration and, thus, the transparency of the EC device.

Traditional EC devices and the insulated glass units (hereinafter “IGUs”) comprising them have the structure shown in FIG. 1. As used herein, the term “insulated glass unit” means two or more layers of glass separated by a spacer 1 along the edge and sealed to create a dead air space (or other gas, e.g. argon, nitrogen, krypton) between the layers. The IGU 2 comprises an interior glass panel 3 and an EC device 4 (the EC device itself is comprised of a stack of thin films 5 and a substrate onto which the thin films are deposited 6).

Many different EC devices, or the IGUs comprising them may be installed throughout one or more buildings, or even in a single room, and controlled by a control system (the control system may be in the room with the EC devices or centrally located in a building or even tied to HVAC or other controls). For example, the different EC devices may have different applied thin films, different exterior coatings or tints, and/or different sizes and/or shapes with one or more independently-controlled segments per device. Also varying are properties such as color and transmissivity in clear or fully dark states, overall conductivity, and performance over temperature. Because of these differences, the control protocol may vary between the differing electrochromic devices. For example, a 0.5 m² device may be tinted at a maximum of 3.0V and 150 mA, while 1.0 m² device might require 4.0V and 600 mA. Or, a device with a very large dynamic range will need to be switched longer at the same voltage and current in order to reach a fully tinted state. As such, different control algorithms are typically applied to different electrochromic device panels or IGUs.

Like electrochromic devices, SPDs and PDLC devices have also been incorporated into smart windows. SPDs are devices which have a thin film containing a suspension of numerous microscopic particles and transparent electrodes on either side of the film. The particles are randomly oriented and reduce the transmittance of the film. However, when an electric field is applied across the film, the particles align with the field, increasing the optical transmittance of the film. PDLCs comprise a liquid crystal layer sandwiched between transparent conductors on a thin plastic film. The liquid crystal particles are randomly oriented in the layer and scatter light—the layer is translucent. However, when a field is applied across the liquid crystal layer, the crystals are aligned to provide an optically transparent film. The degree of transparency is controlled by the voltage applied across the liquid crystal layer.

Traditionally, each controller/interface panel is connected to a central power source in the building. The central power source is generally an alternating current source that is converted to direct current low voltage power using a standard converter. The direct current low voltage power is then run over a power line throughout the building.

FIG. 2 illustrates one smart window wiring configuration in which several controllers are connected to a central power source. A direct current power supply 24, which receives and converts the alternating current building power 22, is connected to a series of controllers 40 via a collection of cables and splitters. The cables are capable of carrying both electrical power as well as data, such as commands related to control of the electrochromic device from a manual control, such as a wall switch 26. The splitters 30 are serially connected along a trunk line. The first in the series of splitters 30 is connected to both the direct current power supply 24 and an input/output (I/O) controller 28, which in turn receives and relays the commands from the wall switch 26. Each of the other splitters 30 is respectively connected to a local window controller 40 via a drop line. Each local window controller 40 controls a respective IGU 50 having one or more electrochromic devices using information and electrical power received via the trunk lines and respective drop line.

One problem with the configuration shown in FIG. 2 is that the configuration demands a lot of power to properly power each of the local window controllers so that each of the connected electrochromic devices may be controlled. While each of the local controllers may be powered and controlled using a low voltage power line, wiring several low voltage lines together in a trunk line architecture as in FIG. 2 can often require a power source in excess of 100 watts, or in some examples a power source in excess of even 1,000 watts. Likewise, such architectures often require high current connections (e.g., over 40 A of current for a 24V application). The above requirements are commonly found for wiring architectures that cover a space about 40-50 m² or larger, though some applications may require similar levels of power and/or current over a smaller area.

Installing smart window wiring architectures such as the wiring shown in FIG. 2, while elegant, can be problematic in some geographic locations, such as in North America, where the National Electric Code (NEC) governs electrical installations. According to the NEC, any DC power source rated between 100 W and 1000 W will be designated “Class 1,” thereby requiring installation techniques similar to high-voltage wiring. For example, NEC requirements for Class 1 wiring can require either armored cable or conduit for wires, and enclosed connections. In addition, higher-current connections (e.g., over 40 A for a 24V, 1000 W supply) require heavy-gauge wire (e.g., AWG 8) with insulation rated for 600V, which can be more difficult to install than other wiring, e.g., AWG18 or AWG22 conductors, insulation rated at 150V, etc.

It is believed that installation of Class 1 wiring may be expensive. The expense is partly due to the equipment, discussed above, required to meet the NEC's specifications. The expense is also partly due to labor since installation of “Class 1” wiring must be done by more skilled workers/electricians than is need for installation of other wiring. The methods and or techniques for Class 1 wiring installation can further contribute to the cost.

There is therefore a need for an alternate wiring architecture that provides low voltage power to a plurality of local window controllers throughout one or more buildings. The low voltage wiring architecture would be rated at not more than 100 W of power in order to fall within Class 2 classification under the NEC guidelines. Such a wiring architecture should be relatively elegant, like the wiring shown in FIG. 2, while achieving cost savings with regard to the wiring equipment, the cost of labor (e.g., the expertise of the installer), and/or the cost of wiring methods/techniques employed.

### BRIEF SUMMARY OF THE INVENTION

One aspect of the disclosure provides for a wiring system for controlling one or more smart windows located within a building. The system may include a building power supply configured to provide electrical power, a plurality of local power supplies, and a plurality of window control circuits. Each local power supply may have a wattage that is not more than 100 watts and not more than the wattage of the building power supply and may be configured to receive and convert power from the building power supply. Each window control circuit may be configured to control the transmissivity of one or more of the smart windows located within the building. Each window control circuit may further be configured to supply power to the one or more smart windows. Each local power supply may be located in close proximity to the building power supply. In some examples, close proximity may include any location within about 5 meters of the building power supply, or within about 10 meters of the building power supply. In yet other examples, close proximity may include any location that is closer to the point at which it is electrically connected to the building power supply than it is to the plurality of window control circuits to which it supplies power. Each window control circuit may also be located closer to each of the smart windows which it controls than to the local power supply from which it receives power. Power from the building power supply may be routed (e.g., transferred, received and subsequently transmitted) to at least one of the smart windows via a power line connecting one of the local power supplies to one of the window control circuits. The power line may be configured to carry both data signals and electrical power.

In some examples, each of the local power supplies may have an NEC rating other than Class 1. In some examples, there may be least four power supplies. In some examples, the building power supply may be electrically connected to no more than ten power supplies.

In further examples, at least one of the plurality of local power supplies may be electrically connected to at least one of the window control circuits via an electrical splitter. In yet further examples, at least one of the plurality of local power supplies may convert the power received from the building supply from alternating current.

A plurality of local power supplies may include a first power supply and a second power supply, and the plurality of window control circuits may include a first plurality of control circuits and a second plurality of control circuits. In some examples, the first plurality of control circuits may be electrically connected in parallel to the first power source and the second plurality of control circuits being electrically connected in parallel to the second power source. In other examples, first plurality of control circuits may be serially electrically connected to the first power source and the second plurality of control circuits being serially electrically connected to the second power source. One of the first plurality of control circuits may be directly electrically connected to the first power source such that no other control circuit is electrically connected between the one control circuit and the first power source. In some examples, that one control circuit may be capable of cutting off electrical power to the other control circuits of the first plurality of control circuits when that one control circuit is not in operation. In other examples, that one control circuit may be capable of relaying electrical power to the other control circuits of the first plurality of control circuits when that one control circuit is not in operation.

In some examples, the power line may include a 150V rated insulation. The thickness of the power line may be rated at 18 gauge (AWG). Alternatively, the thickness of the power line may be rated at 22 gauge (AWG).

Another aspect of the disclosure provides for a method of converting an NEC Class 1 rated wiring system for smart windows into an NEC Class 2 rated wiring system. The method may include providing a plurality of individual power supplies. Each individual power supply may have a wattage that is not more than 100 watts. The method may also include connecting each of the plurality of individual power supplies to an alternating current building power supply used in the NEC class 1 rated wiring system. The method may also include disconnecting a plurality of window control circuits from the NEC class 1 rated wiring system. Each window control circuit may be configured to control the transmissivity of one or more of the smart windows located within the building. Each window control circuit may further be configured to supply power to the one or more smart windows.

The method may further include connecting each of the plurality of window control circuits to one of the individual power supplies. The method may yet further include routing power from the building power supply to at least one of the smart windows via a power line connecting one of the individual power supplies to one of the window control circuits.

In some examples, the method may further include routing data signals to one of the window control circuits via the power line.

In some examples, the plurality of individual power supplies may be connected in close proximity to the alternating current building power supply. In some examples, the plurality of individual power supplies may be connected to the alternating current building power supply such that each of the plurality of individual power supplies is located within about 5 meters, or within about 10 meters, of the point of connection to the alternating current building power supply. Each of the individual power supplies may be positioned closer to the point of connection than to the plurality of window control circuits to which it supplies power. Each of the plurality of window control circuits may also be connected to an individual power supply at a distance such that each window control circuit is located closer to one of the plurality of smart windows than to the individual power supply from which it receives power.

### BRIEF DESCRIPTION OF THE DRAWINGS

FIG. 1 is a schematic view of an insulated glass unit comprising an electrochromic device.

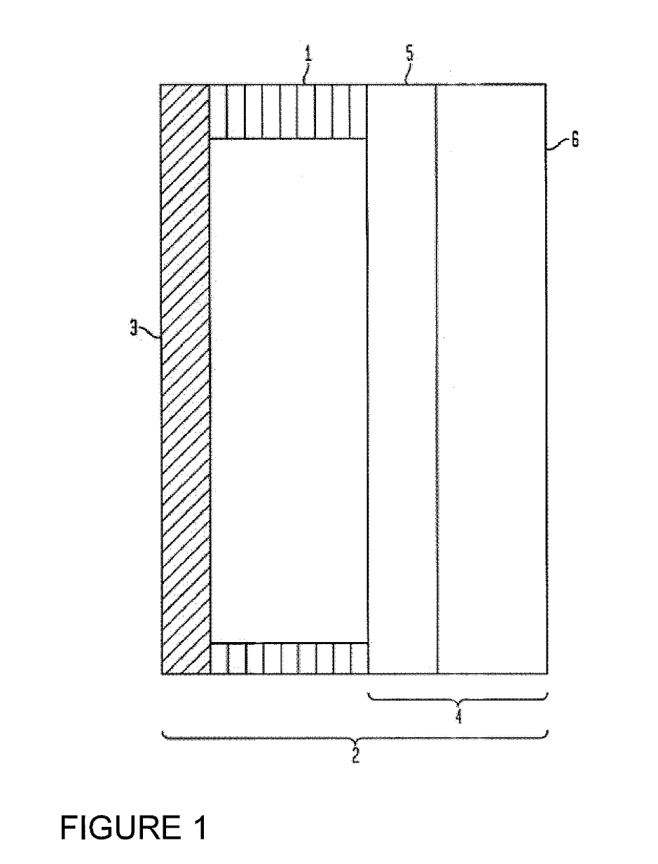

FIG. 2 is a schematic of an electrochromic control system.

FIG. 3 is a schematic of an electrochromic control system in accordance with an embodiment of the present disclosure.

FIG. 4 is a schematic of a portion of an electrochromic control system in accordance with another embodiment of the present disclosure.

FIG. 5 is a schematic of an electrochromic control system in accordance with another embodiment of the present disclosure.

### DETAILED DESCRIPTION

One object of the present invention is to provide an improved wiring architecture for powering a plurality of local window controllers that individually control the operation of a plurality of respective smart windows. The improved architecture permits installation of multiple controllers for smart windows having an electrical designation other than a Class 1 designation (e.g., having a “Class 2” designation). This reduces costs associated with the parts and installation (e.g., technique, labor) of the wiring architecture. Specifically, the disclosed improved wiring architecture includes a plurality of individual controllers that are linked via communication lines (e.g., Ethernet cable). The individual controllers are also connected to a plurality of power sources in order to reduce the power requirements for any single power source.

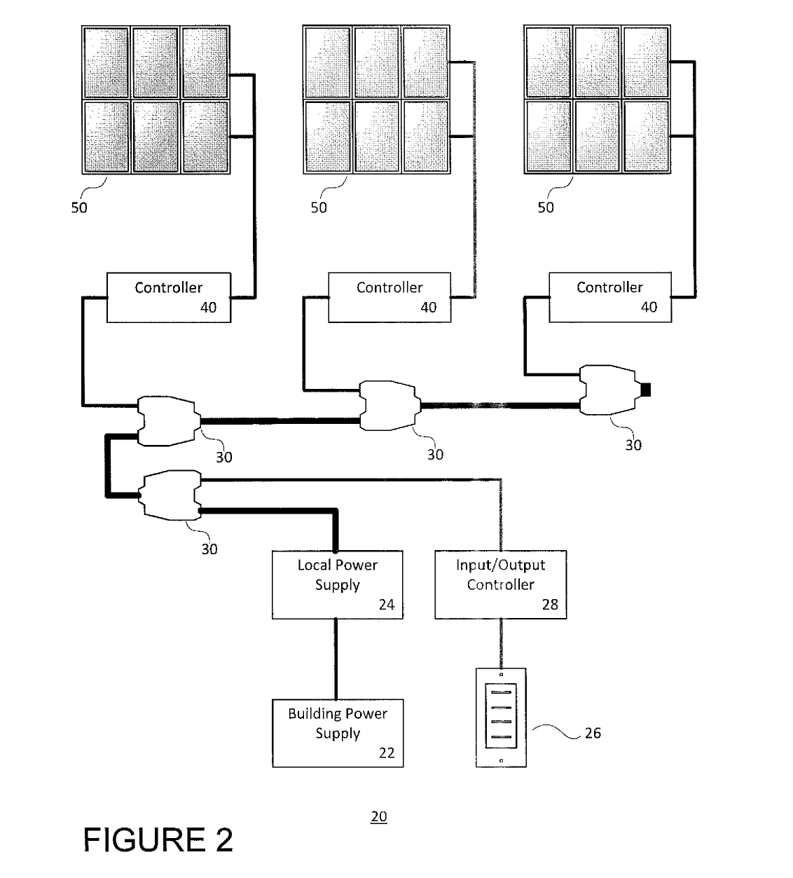

Another object of the present invention is to provide a method of wiring the improved wiring architecture. Because the improved architecture is not classified as Class 1 wiring by the NEC, the wiring requirements are less prohibitive and/or cost restrictive as for wiring methods to install other wiring architectures, such as the architecture of FIG. 2.

Yet another object of the present invention is to provide a method of converting a Class 1 wiring architecture (e.g., as shown in FIG. 2) to a different class wiring architecture having less restrictions (e.g., in terms of equipment, required skill of technicians, and/or wiring techniques).

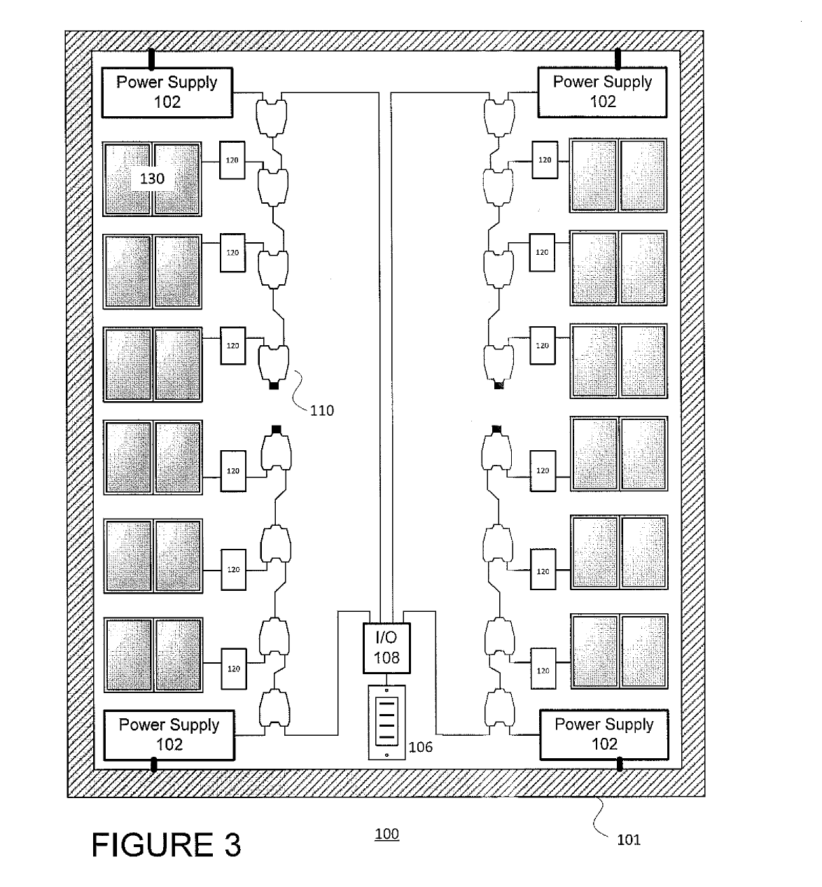

In accordance with the present invention, FIG. 3 illustrates a functional block diagram of an improved wiring architecture 100 having a Class 2 NEC rating. The wiring architecture 100 includes a bank of smaller (i.e., 100 watts or less) Class 2 DC power supplies 102. Each of the power supplies 102 is electrically connected to a building power supply 101, which may run throughout the building. In some embodiments, the term “building power supply” may refer to the building alternating current (AC) power. In some embodiments, the “building power supply” may refer to an NEC rated Class 1 power source that converts high voltage AC power to high voltage direct current (DC) power. Ultimately, the term “building power supply” may refer to any component capable of feeding Class 1 power to an input of a Class 2 power supply.

In, the example of FIG. 3, four power supplies 102 are connected to the building power supply 101. In other examples, up to ten 100 W power supplies 102 may be connected to the building power supply. In other examples involving Class 2 power supplies having wattage ratings lower than 100 W, more than ten power supplies 102 may be connected to the building power supply.

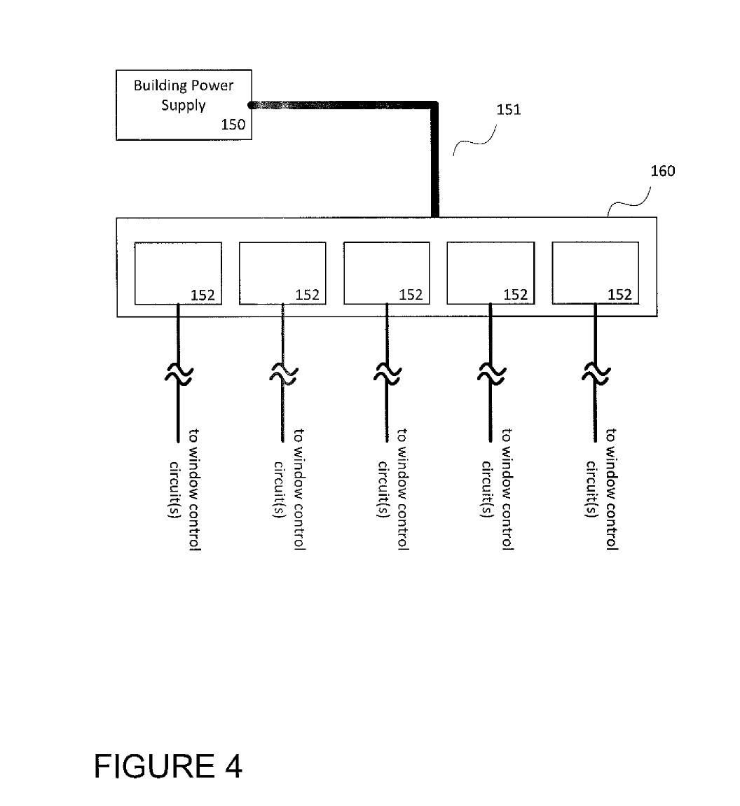

In the example of FIG. 3, the Class 2 power supplies 102 are distributed among different locations within a building and are connected to the building power supply 101 at different points. In other examples, such as the example of FIG. 4, Class 2 power supplies 152 may be “clustered” at a single location of the building and connected to the building power supply 150 at a single point. A Class 1 power cable 151 may be run from the building power supply 150 to a panel 160 containing each of the Class 2 power supplies 152. Smaller Class 2 power cables may then be run from the Class 2 power sources 152 to the control circuits throughout the building in similar fashion to the example of FIG. 3. The configuration of FIG. 4 avoids the need to separately install each power supply, cutting down both time and costs associated with installation.

In the example of FIG. 4, each Class 2 power supply 152 may be located in close proximity to the building power supply 150. Close proximity to the building power supply may include any position for which the local power supply is easily connectable to the building power supply by a standard length of Class 1 rated cable. In other examples, close proximity may include any location within about 2 meters of the building power supply, within about 5 meters of the building power supply, or within about 10 meters of the building power supply. In yet other examples, close proximity may include any location that is closer to the point at which it is electrically connected to the building power supply than it is to the plurality of window control circuits to which it supplies power.

The Class 2 power cable between (i.e., electrically connecting) the power supply 152 and a control circuit may be up to about 100 meters long. In examples where a longer cable is necessary to connect the power supply 152 to the control circuit, it may be preferable to connect the power supply 152 to the building power supply 150 at a different point, as depicted in FIG. 3. For instance, the control circuit may be located closer to the smart window it controls than to the power supply 152. In some embodiments, it may be preferable for the control circuit to be located within about 2 meters of the smart window, within about 5 meters, or within about 10 meters.

Returning to FIG. 3, instead of a single trunk line of Class 1 rated power cables (as shown in FIG. 2), the wiring architecture 100 includes Class 2 rated power cables. Each power cable is connected to one or more individual window control circuits 120. Each of the window control circuits is capable of controlling a feature (e.g., transmissivity, opacity, color) of a connected insulated glass unit 130 having one or more electrochromic devices. While FIG. 3 (as well as FIG. 4, which is discussed in greater detail below) depicts the control circuits 120 as connected to electrochromic device, it will be recognized that the control units may similarly be connected other smart window devices, such as suspended particle devices (SPDs) polymer dispersed liquid crystal (PDLC), photovoltaic, and photochromic devices.

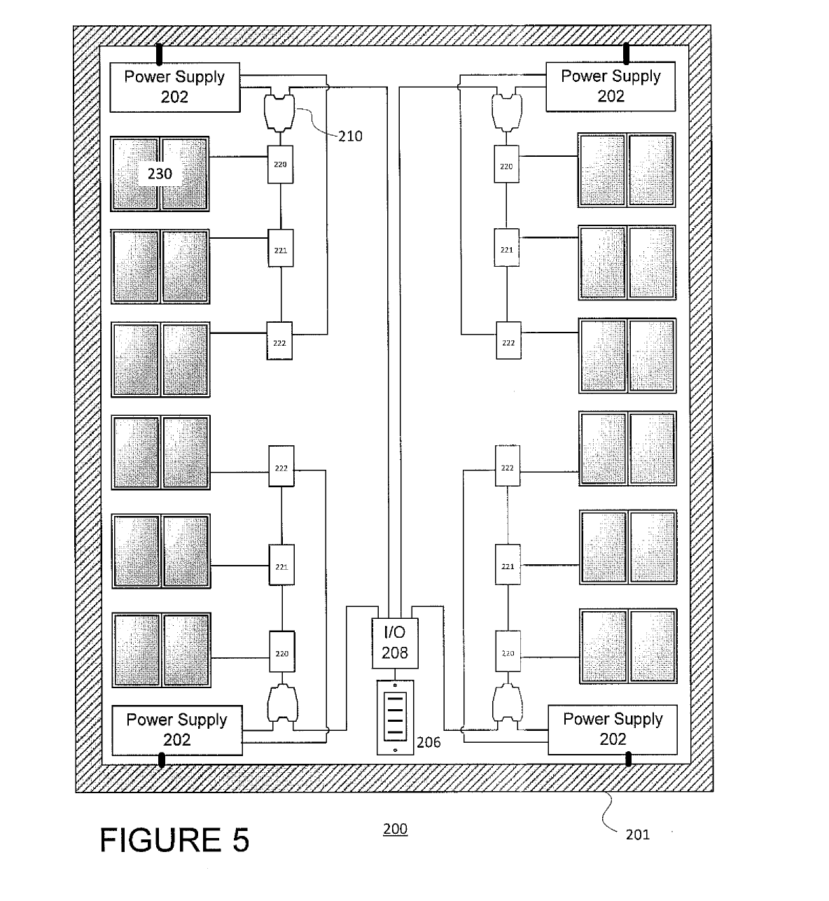

In the example of FIG. 3, the power cables are connected using electrical splitters 110. In other examples (such as in FIG. 5, discussed in greater detail below), the power cables may be connected without using electrical splitters.

Each of the local power supplies 102 may be separately connected to the power source of the building in which the wiring is located. Generally, there are multiple points at which a building's alternating current (AC) power supply (e.g., 110V, 220V) is relatively accessible, and a direct current (DC) converter may be connected to the AC power supply at all or some of those points. Each converter may be a relatively low voltage converter, such as 12 volts or 24 volts. Each converter may also be a relatively small power supply, rated at not more than 100 watts. Thus, each converter may function as a DC power supply, thereby permitting the electrochromic devices located throughout a large building (e.g., covering more than about 40 square meters) to be connected to various power sources (e.g., some devices connected to the AC power source via a first converter, and other devices connected via a second converter, etc.)

In the example of FIG. 3, every group of three control circuits 120 is connected in parallel. Specifically, each local power supply 102 is connected to three control circuits 120 via a series of cables and splitters 110. Each of the control circuits 120 receives electrical power directly from the power supply 102, without the received electrical power passing through any of the other control circuits. Thus, each of the three control circuits connected to a respective power supply is considered to be in parallel with the other control circuits of that group.

In other examples, such as the example of FIG. 5, every group of control circuits may be connected serially, such that each of the control circuits connected to a respective power supply is considered to be in series with the other control circuits of that group. Specifically, in FIG. 5, a first control circuit 220 is directly connected to a power supply 202, which receives power from a building power supply 201, and on some examples converts the received power from AC to DC. A second control circuit 221 is then indirectly connected to the power supply 202 via the first control circuit 220. Similarly, a third control circuit 222 is directly connected to the second control circuit 221 and indirectly connected to each of the upstream power supply 202 and first control circuit 220. The third control circuit 222 then loops back to the power supply 202 to complete the serial connection.

Because the control circuits are connected serially, the power supplied to each control circuit will generally be a higher voltage with a lower current (as compared to the parallel arrangement of FIG. 3), with each control circuit 220-222 functioning as a voltage divider such that the voltage is stepped down from one control circuit to the next. Thus, operation of the first control circuit 220 may affect the operation of the downstream control circuits 221 and 222. For instance, if power to the first control circuit 220 is cut off, power to the downstream control circuits 221 and 222 may also be cut off. Alternatively, power may be cut off from a single control circuit in the series by shorting that control circuit out of the serial connection. In such an alternative example, power to the downstream control circuits can be left on. For instance, power to the first control circuit 220 may be cut off by shorting the first control circuit out of the serial connection between the power supply 202 and the second control circuit 221. The second control circuit would then receive power directly from the power supply 202, thus maintaining the serial connection between the power supply 202 and the other downstream control circuits that have not been shorted out. In such an example, each control circuit may be selectively shorted out, regardless of the status of the other control circuits, and the power supply may be configured to adjust the amount of power supplied to the series of control circuits based on the then-present power requirements of the series of control circuits.

In some examples, the control circuits may be connected in parallel such that each control circuit is directly connected to the power source, and may further be interconnected to one another via additional power lines. Thus, if a direct connection between any one control circuit and the power source is disabled, the control circuit may still be indirectly connected to the power source via another control circuit (similar to the manner described above). Depending on the relative operation or power needs of the respective electrochromic devices, load balancing may be implemented to ensure than no electrical wire carries more than 100 watts of power. For example, if the direct connection between the power source and one control circuit is disabled, power may be rerouted (e.g., alternating or changing the route by via which the power is transferred, or received and subsequently transmitted) through another control circuit that is not presently supplying power to any electrochromic devices in order to balance power loads among the control circuits.

In some further examples, the local control circuits may be connected to the power source via any combination of parallel and serial power lines. In other words, some control circuits may be connected serially, while others are connected in parallel.

The power lines described above may include about 150 volt insulation and relatively high gauge (e.g., AWG 18 or AWG 22) conductors. Additionally, the power lines do not require an electrical conduit, due to the relatively low power rating. Further, the power lines may be run through plenums in order to interconnect the power supply and/or control circuit(s).

The connectors (e.g., splitters 110 of FIG. 3, splitters 210 of FIG. 5, or another electrical connector) used to connect the power supply and control circuits need not be contained in a junction box. Due to the Class 2 power rating of the system, the connectors may be left exposed or open.

The above described power lines may be capable of carrying data signals along with electrical power. For example, the power line may be a low voltage power line or may rely on power line communication (PLC). In addition to the power/data cables, the control circuits may be interconnected via communication (i.e., communication only) cables. The communication cables may be beneficial to transfer information among control circuits that are connected to separate power sources.

The control circuits also receive data from an input/output (I/O) connector 108, which may itself send and/or receive signals to and/or from a wall switch 106 or to and/or from other sensors or computers located within the building or remotely. The PLC wires and communication cables may carry information relating to the status or operation or desired operation of the control circuits, such as the information described in concurrently pending U.S. patent application Ser. Nos. 13/435,719 and 13/650,952, the disclosures of which are hereby incorporated by reference in their entirety herein. For example, the control circuits may communicate identification information such as: (a) product model and serial number; (b) manufacturing date; (c) device shape; (d) device size; (e) device surface area; (f) control parameters including, e.g., maximum switching voltage and/or current for tinting and/or clearing; (g) properties including leakage current and/or switching speed; (h) installation location; (i) constituent materials; (j) number and size of independently-controllable segments; (k) minimum and maximum tint levels and corresponding holding voltages; (l) internal series resistance; and (m) any other physical or operational parameters necessary for appropriate control. Each control circuit may further communicate a current status of the one or more electrochromic devices being controlled by that control circuit (e.g., whether the device is fully tinted, whether the device is fully bleached, an amount of power currently being supplied to each electrochromic device, an amount of power currently being supplied to the control circuit, etc.).

In some examples, communication cables may connect the control circuits to external input sources that provide information regarding proper control of the respective electrochromic devices connected to the control circuits. The external input sources may include several room characteristic sensors, including but not limited to an occupancy sensor, an indoor temperature sensor, a Building Management System (BMS), and a daylight sensor. Each of these sensors may provide information necessary to determine a proper state of operation for one or more of the respective electrochromic devices. For example, the occupancy sensor may provide information indicating whether a room in which the electrochromic device is located is currently in use.

In some examples, it may be desirable to operate one electrochromic device differently from another electrochromic device depending on whether the rooms of the respective devices are in use or not. For further example, the indoor temperature sensor may provide information indicating whether each room's current temperature is suitable for occupation. Similarly, the BMS may provide an input indicating when lights in the room are scheduled to automatically turn on or off, indicating the room's standard hours of operation. The BMS may also provide an input indicating hours for automatically enabling and disabling a security system of a building in which the electrochromic device is located, similarly indicating the building's standard hours of operation.

The daylight sensor may measure an amount of brightness in a room, indicating a transmissivity percentage value of the electrochromic device (e.g., the brighter the room, the more transmissive the device). Collectively, these inputs may be useful for determining whether it is desirable that a electrochromic device be operated at a lowest possible cost (highest energy efficiency), for instance in such cases when the room is determined to be vacant, and/or when it is desirable that the electrochromic device be operated to make occupation of the room comfortable.

The external input sources may also include climate characteristic indicators and sensors, including but not limited to a Heating Ventilation and Air-Conditioning (HVAC) system, and an outdoor temperature sensor. The HVAC system may provide inputs relating to climate control of a room in which an electrochromic device is located (e.g., heating the room, cooling the room, etc.). The outdoor temperature sensor, similarly, may provide inputs indicating the temperature of an outdoor location.

A user control unit may provide additional inputs indicating preferences regarding operation of any combination of the electrochromic devices. The user control unit may include a user interface for inputting these preferences. Preferences may include a maximum transmissivity input, a minimum transmissivity setting, a heating setting, a cooling setting, and user override inputs, overriding inputs received from the external input sources. Preferences may also include, without limitation, an input indicating any one of a desired brightness of the space, solar angles likely to cause glare and threshold light levels at which glare might be a problem.

The external input sources are not limited to the above described sensors and inputs, but may include any sensor or input useful for identifying either a characteristic of the electrochromic device, a characteristic of the interior space, or an energy management preference. Furthermore, each of the specified external input sources may be utilized for purposes in addition to those described above. For example, the HVAC system may provide BMS-type inputs, including a time of day. For further example, the user control unit may provide occupancy sensor-type information, including current usage of an interior space associated with one or more electrochromic devices.

Such a wiring architecture would permit for centralized control of each of the local electrochromic device control circuits. For example, a central controller may be a central computer or a building management system located in the same building as the power source(s) and the control circuits, or at a remote site. The central controller may receive information (e.g., address information, status information, input data, etc.) from each of the individual local controllers via the communication wires. The central controller may in turn control each of the individual local controllers based on the information received. In such an example, because the central controller might not be connected to the power supply of the local controller, controlling the power supplied to each of the individual local controllers (e.g., controlling a switch to open or cut off power between a DC power supply and an electrochromic device) may be performed locally (e.g., at the local controller, at a device located within proximity of the local controller, etc.). Such power supply control, however, may be based on instructions received from the central controller.

The wiring described in each of the above examples has been described as spanning a single building. In other examples, the wiring may span more than one building. For example, several individual control units in multiple buildings may be linked together via communication wires, while the control units located in any one building may each be connected to that respective building's power source. Such a system would permit for centralized control of several control units spanning more than one building, while only requiring the linking or interconnecting of those units via communication lines, not power lines.

The example systems described above may be constructed using the method described herein. It should be understood that the following operations do not have to be performed in the precise order described below. Rather, various operations can be handled in a different order, or simultaneously. Moreover, operations may be added or omitted.

A plurality of low wattage power supplies may be connected to a building power supply. In those examples where the building power supply is an AC supply and the low wattage power supplies are DC power supplies, a standard converter may be used to provide AC/DC electrical conversion. The low wattage power supplies may be rated as Class 2 power supplies handling not more than 100 watts.

Each of a plurality of control circuits may be connected, via power lines, to one the plurality of low wattage power supplies. In some examples, a plurality of control circuits may be connected to a single low wattage power supply. The electrical (e.g., current, power) demands made on each power supply by the control circuitry preferably do not exceed 100 watts at any power supply. In those examples where multiple control circuits are connected to a single power supply, the control circuits may be connected serially, parallel, or by some combination of the two.

In some examples, the control circuits may be interconnected to one another via communication lines such that signals, for instance data signals carrying information such as the information described above, may be communicated among the control circuits. In some examples, the control circuits may further be linked to input devices, such as temperature sensors, light sensors, etc., via the communication lines.

In some examples, the control circuits may further be connected to a control controller that is capable of controlling each of the control circuits, via communication lines. The central controller may then receive information from any of the control circuits and/or sensors or other input units, and determine a proper operation of each control circuit vis-à-vis the devices connected to that control circuit. In some examples, the central controller may determine whether the supply of power to a specific control circuit should be cut off or disabled.

Replacement of the wiring architecture of FIG. 2 with the above described wiring architecture may be performed using the following process. The large DC power supply of FIG. 2 may be replaced with a bank of relatively lower wattage power supplies rated at 100 watts or less. The bank of power supplies may include up to ten supplies. Each DC supply may then be connected to a portion of the control circuits located within the building(s). For example, if there are four local DC power supplies distributed throughout a building, and if there are twelve control circuits, three control circuits may be wired to each of the power supplies so as to distribute power evenly. The control circuits may be connected to the respective power supplies using a sufficient length of electrical cable (or multiple cables connected via splitters or other electrical connectors). In some examples, between about 80 meters and about 100 meters of cable may be used to connect the control circuits to their respective local power source. The cables may be Class 2 rated PLC cable, or other electrical wiring capable of carrying low voltage electrical power, and optionally data signals.

Replacing the large DC power supply may additionally or alternatively include connecting one or more voltage converters to the large DC supply (e.g., a step down convertor) in order than each smaller supply is rated at 100 watts or less. The same replacement and/or installation may be performed at other locations of the building(s).

Additionally, the single trunk line of FIG. 2 may be replaced by a cluster of low wattage electrical cables (i.e., certified as Class 2 cables that carry 100 watts or less). The cables may be pulled through the building simultaneously, resulting in very little extra cost and effort compared to installing a single trunk line.

Replacement may be facilitated by use of a retrofit kit. The kit would preferably include a control panel having a plurality of NEC Class 2 rated power supplies. The kit would also preferably include between about 80 and about 100 meters of plenum-rated Class 2 cable per power supply included in the kit. These Class 2 cables would replace the Class 1 rated trunk line.

For example, if a building were to include twenty IGUs, and each IGU were to be controlled by a separate control circuit operating on power supplied by a trunk line of NEC rated Class 1 cable, the retrofit kit could be used to convert the Class 1 power supply system of the building into a Class 2 power supply system. First, the trunk line of NEC rated Class 1 cables would be uninstalled. The building power supply could then be wired using a relatively shorter Class 1 cable to a panel having five low voltage DC power supplies rated at 100 watts or less. Each power supply could then be wired (either in a star topology or daisy chain topology or serially) to four of the twenty control circuits using NEC rated class 2 power cables (in some examples also capable of carrying data signals).

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A wiring system for controlling one or more smart windows located within a building, the system comprising:
a building power supply configured to provide electrical power;
a plurality of local power supplies, each local power supply having a wattage that is 100 watts or less and lower than the wattage of the building power supply and being configured to receive and convert power from the building power supply;
a plurality of window control circuits, each window control circuit configured to control the transmissivity of one or more of the smart windows located within the building, and further configured to supply power to the one or more smart windows,
wherein each local power supply is located closer to the point at which it is electrically connected to the building power supply than to the plurality of window control circuits to which said local power supply supplies power,
wherein each window control circuit is located closer to each of the one or more smart windows which it controls than to the local power supply from which said window control circuit receives power, and
wherein power from the building power supply is routed to at least one of the smart windows via a power line connecting one of the local power supplies to one of the window control circuits.

2. The wiring system of claim 1, wherein the power line connecting one of the local power supplies to one of the window control circuits is configured to carry both data signals and electrical power.

3. The wiring system of claim 1, wherein each of the plurality of local power supplies has a National Electric Code rating of Class 2.

4. The wiring system of claim 1, wherein the plurality of local power supplies comprises at least four power supplies.

5. The wiring system of claim 1, wherein the building power supply is electrically connected to no more than ten power supplies.

6. The wiring system of claim 1, wherein at least one of the plurality of local power supplies is electrically connected to at least one of the window control circuits via an electrical splitter.

7. The wiring system of claim 1, wherein at least one of the plurality of local power supplies converts the power received from the building supply from alternating current.

8. The wiring system of claim 1, wherein plurality of local power supplies comprises a first power supply and a second power supply, and wherein the plurality of window control circuits comprises a first plurality of control circuits and a second plurality of control circuits, the first plurality of control circuits being electrically connected in parallel to the first power source and the second plurality of control circuits being electrically connected in parallel to the second power source.

9. The wiring system of claim 1, wherein plurality of local power supplies comprises a first power supply and a second power supply, and wherein the plurality of window control circuits comprises a first plurality of control circuits and a second plurality of control circuits, the first plurality of control circuits being serially electrically connected to the first power source and the second plurality of control circuits being serially electrically connected to the second power source.

10. The wiring system of claim 9, wherein one of the first plurality of control circuits in directly electrically connected to the first power source such that no other control circuit is electrically connected between said one control circuit and said first power source, and wherein said one control circuit is capable of cutting off electrical power to the other control circuits of the first plurality of control circuits when said one control circuit is not in operation.

11. The wiring system of claim 9, wherein one of the first plurality of control circuits in directly electrically connected to the first power source such that no other control circuit is electrically connected between said one control circuit and said first power source, and wherein said one control circuit is capable of relaying electrical power to the other control circuits of the first plurality of control circuits when said one control circuit is not in operation.

12. The wiring system of claim 1, wherein said power line includes about 150V rated insulation.

13. The wiring system of claim 1, wherein the thickness of said power line is rated at 18 gauge (AWG).

14. The wiring system of claim 1, wherein the thickness of said power line is rated at 22 gauge (AWG).

15. A method of converting an NEC Class 1 rated wiring system for controlling a plurality of smart windows into an National Electric Code Class 2 rated wiring system, said method comprising:
providing a plurality of individual power supplies, each individual power supply having a wattage that is 100 watts or less;
connecting each of said plurality of individual power supplies to an alternating current building power supply utilized in the National Electric Code class 1 rated wiring system;
disconnecting a plurality of window control circuits utilized in the National Electric Code class 1 rated wiring system, each window control circuit configured to control the transmissivity of one or more of the smart windows located within the building, and further configured to supply power to the one or more smart windows;
connecting each of the plurality of window control circuits to one of the individual power supplies.
routing power from the building power supply to at least one of the smart windows via a power line connecting one of the individual power supplies to one of the window control circuits.

16. The method of claim 15, further comprising:
routing data signals to one of the window control circuits via the power line.

17. The method of claim 15, wherein the plurality of individual power supplies is connected to the alternating current building power supply such that each of the plurality of individual power supplies is located within about 5 meters of the point of connection to the alternating current building power supply.

18. The method of claim 15, wherein the plurality of individual power supplies is connected to the alternating current building power supply such that each of the plurality of individual power supplies is located within about 10 meters of the point of connection to the alternating current building power supply.

19. The method of claim 15, wherein the plurality of individual power supplies is connected to the alternating current building power supply such that each of said individual power supplies is positioned closer to the point at which it is electrically connected to the building power supply than to the plurality of window control circuits to which said local power supply supplies power.

20. The method of claim 15, wherein said plurality of window control circuits are connected to said one of the individual power supplies such that each window control circuit is located closer to one of said plurality of smart windows than to the individual power supply from which said window control circuit receives power.
